(19) United States
(12) Patent Application Publication
(10) Pub. No.: US 2025/0289005 A1
(43) Pub. Date: Sep. 18, 2025

(54) VORTEX ELECTRIC FIELD PURIFICATION DEVICE AND DESIGN METHOD THEREFOR

(71) Applicant: AirQuality Technology (Shanghai) Co., Ltd., Shanghai (CN)

(72) Inventors: Kui CAI, Shanghai (CN); Shanqing MENG, Shanghai (CN); Shidan LONG, Shanghai (CN); Lisun WANG, Shanghai (CN)

(21) Appl. No.: 19/014,809

(22) Filed: Jan. 9, 2025

Related U.S. Application Data
(63) Continuation of application No. PCT/CN2024/101225, filed on Jun. 25, 2024.

(30) Foreign Application Priority Data
Mar. 12, 2024 (CN) 2024102781288

(51) Int. Cl. B03C 3/08; B03C 3/36; B03C 3/41; B03C 3/47

(52) U.S. Cl. CPC B03C 3/08; B03C 3/365; B03C 3/41; B03C 3/47; B03C 2201/10

(57) ABSTRACT

The present invention relates to a vortex electric field purification device and a design method therefor, belonging to the technical field of air purification. The vortex electric field purification device includes a frame, where a dust collection area and an ionization area are arranged inside the frame in parallel, both the dust collection area and the ionization area include a plurality of polar plates parallel to each other and arranged at intervals, the first direction is parallel to a direction from an air inlet side of the purification device to a leeward side of the purification device, and the second direction is perpendicular to the first direction. The vortex electric field purification device can avoid the phenomenon of ignition or arcing of the ionization area and the dust collection area, has high reliability, and is economical and durable.

### CROSS-REFERENCE TO RELATED APPLICATIONS

The present application claims priority to Chinese Patent Application No. 2024102781288, filed on Mar. 12, 2024, the entire disclosure of which is incorporated herein by reference.

### TECHNICAL FIELD

The present invention belongs to the technical field of air purification, and particularly relates to a vortex electric field purification device and a design method therefor.

### BACKGROUND

The principle of a tunnel electrostatic purifier and a fume electrostatic purifier is to purify air and fume by electrostatic action. Specifically, the tunnel electrostatic purifier uses an electrostatic field to enable charged particles to move directionally under the action of an electric field force and be collected or adsorbed on a polar plate. Meanwhile, odor therein is removed by a subsequent deodorization device, and finally, clean air is discharged. The fume electrostatic purifier enables fume particles to be charged through an electrostatic field, move directionally under the action of the electric field force and be adsorbed on the polar plate. Meanwhile, most of grease is collected through a flow equalizing plate and an oil collecting disk, and finally, clean air is discharged. Most of the tunnel electrostatic purifiers and the fume electrostatic purifiers in the current market are operated by a plurality of ion boxes connected in series, and the same high-voltage power supply is used to supply power for the serial ion boxes. Therefore, as long as the phenomenon of high-voltage ignition or low-voltage arcing occurs in any ion box, the high-voltage power supply will automatically fail and stop working and enter a power-off protection state. At this time, the whole serial ion boxes cannot perform air purification operation, so that the air purification efficiency is affected and the safety of the site environment cannot be ensured.

### SUMMARY

In view of the shortcomings in the prior art, a vortex electric field purification device and a design method therefor are proposed.

To achieve the foregoing objective, the present invention provides the following technical solutions.

According to a first aspect, the present invention provides a vortex electric field purification device, including a frame, where a dust collection area and an ionization area are arranged inside the frame in parallel, both the dust collection area and the ionization area include a plurality of polar plates parallel to each other and arranged at intervals, a minimum distance between high-voltage polar plates of the dust collection area and low-voltage polar plates of the ionization area in a first direction is not less than a distance between low-voltage polar plates and the high-voltage polar plates of the dust collection area in a second direction, the first direction is parallel to a direction from an air inlet side of the purification device to a leeward side of the purification device, the second direction and the first direction are located in a same horizontal plane, and the second direction is perpendicular to the first direction.

Further, a minimum distance d₂ between the low-voltage polar plates of the ionization area and the low-voltage polar plates of the dust collection area in the first direction is not less than a distance d₁ between the high-voltage polar plates and the low-voltage polar plates of the dust collection area in the second direction.

Further, if a distance between high-voltage polar plates and the low-voltage polar plates of the ionization area is d₄, d₄≥4 d₂.

Further, the high-voltage polar plates and the low-voltage polar plates of the ionization area are respectively connected to a high-voltage power supply, an ionization electric field is formed between the high-voltage polar plates and the low-voltage polar plates of the ionization area, the high-voltage polar plates of the dust collection area are activated by the ionization electric field to generate a vortex electric field, and a corresponding relationship between an absolute value of an induced voltage of the vortex electric field and d₁ is:

the absolute value of the induced voltage/d₁=0.7-1.3 kV/mm.

Further, the high-voltage polar plates of the ionization area are connected to a high-voltage end of the high-voltage power supply through a conductive rod, an avoiding hole for the conductive rod to penetrate through is formed in each of the low-voltage polar plates of the ionization area, the avoiding hole is set as a waist-shaped hole, and if a minimum diameter of the waist-shaped hole is D and an absolute value of a voltage of the ionization electric field is U, D/U≥2 mm/kV.

Further, wind deflectors are arranged at the tops and bottoms of the low-voltage polar plates of the ionization area, the wind deflectors are arranged obliquely, and a distance between an end portion of each of the wind deflectors close to the air inlet side of the purification device and the frame is less than a distance between an end portion of each of the wind deflectors close to the leeward side of the purification device and the frame.

Further, a distance between ionization sawteeth on the high-voltage polar plates of the ionization area and the low-voltage polar plates in the second direction is not greater than a minimum distance of the ionization sawteeth and the wind deflectors in a third direction, the third direction and the first direction are located in a same vertical plane, and the third direction is perpendicular to the first direction.

Further, the bottoms of the low-voltage polar plates of the ionization area are connected to the frame through a connecting plate, and a height of the connecting plate is not greater than a height of a lower edge strip of the frame.

Further, in the ionization area, a mounting hole for the first conductive rod to penetrate through is formed in each of the high-voltage polar plates, a first ionization sawtooth is arranged on a side surface of each of the high-voltage polar plates close to the air inlet side of the purification device, a second ionization sawtooth is arranged on a side surface of each of the high-voltage polar plates close to the leeward side of the purification device, a distance between the first ionization sawtooth and the mounting hole in the first direction serves as a second distance, a distance between the second ionization sawtooth and the mounting hole in the first direction serves as a third distance, and the second distance is less than the third distance.

Further, the first ionization sawtooth and the second ionization sawtooth have the same structure, the first ionization sawtooth and the second ionization sawtooth are staggered in a height direction of the purification device, and a difference value between the second distance and the third distance is 3/10 to ½ of a distance between adjacent second ionization sawteeth.

Further, the high-voltage polar plates of the ionization area and two low-voltage polar plates adjacent thereto form an ionization interval C₁, the high-voltage polar plates of the dust collection area and two low-voltage polar plates adjacent thereto form a dust collection interval C₂, and in the second direction, C₁≥3 C₂.

Further, in the second direction, a distance between a sawtooth tip of the high-voltage polar plates of the ionization area close to the air inlet side and the low-voltage polar plates adjacent thereto is d₅, and in the first direction, a width of each of the high-voltage polar plates and the low-voltage polar plates of the ionization area is three times d₅.

According to a second aspect, the present invention further provides a method for designing a vortex electric field purification device, including the following steps:
obtaining an induced voltage of the dust collection area as well as a minimum distance between the high-voltage polar plates of the dust collection area and the low-voltage polar plates of the ionization area in the first direction according to a distance between the positions of the high-voltage polar plates and the low-voltage polar plates of the dust collection area in the second direction, and determining the positions of the low-polar plates of the ionization area in the first direction;
obtaining a distance between the high-voltage polar plates and the low-voltage polar plates of the ionization area in the first direction as well as a minimum distance between the high-voltage polar plates of the ionization area and the high-voltage polar plates of the dust collection area in the first direction according to the distance between the positions of the high-voltage polar plates and the low-voltage polar plates of the dust collection area in the second direction, and determining the positions of the high-voltage polar plates of the ionization area in combination with the positions of the low-voltage polar plates of the ionization area; and
obtaining a voltage of the ionization electric field of the ionization area according to the distance between the high-voltage polar plates and the low-voltage polar plates of the ionization area in the second direction.

Further, if the distance between the high-voltage polar plates and the low-voltage polar plates of the ionization area in the second direction is d₄, 0.5 kV/mm≤the absolute value of the voltage of the ionization electric field of the ionization area/d₄≤1 kV/mm.

The present invention has the following beneficial effects:

the high-voltage polar plates of the dust collection area protrude toward the ionization area, the distance from the high-voltage polar plates of the dust collection area to the low-voltage polar plates of the ionization area is adjusted, the dust collection area can generate the vortex electric field through the ionization electric field of the ionization area, and the phenomenon of ignition or aching of the dust collection area can be avoided, so the vortex electric field purification device has high reliability and high safety, and is economical and durable. A plurality of vortex electric field purification devices are connected in series, so the failure of a certain vortex electric field purification device will not affect the normal work of other vortex electric field purification devices, thereby ensuring that all the vortex electric field purification devices will not failure at the same time when the efficiency is within the controllable range, and avoiding the influence on the efficiency of the whole purification system caused by the fact that all other purification devices stop working when one purification fails.

### BRIEF DESCRIPTION OF THE DRAWINGS

FIG. 1 is an axial side view of a vortex electric field purification device according to an embodiment of the present invention;

FIG. 2 is a side view of a vortex electric field purification device according to an embodiment of the present invention; and

FIG. 3 is a flow block diagram of a method for designing a vortex electric field purification device according to an embodiment of the present invention.

### DETAILED DESCRIPTION OF THE EMBODIMENTS

To make those skilled in the art better understand the technical solutions of the present invention, the technical solutions of the present invention are clearly and completely described below with reference to the accompanying drawings of the present invention. Other embodiments obtained by a person of ordinary skill in the art based on the embodiments of the present application without creative efforts shall fall within the protection scope of the present application. In addition, the directional terms mentioned in the following embodiments, such as “up”, “down”, “left” and “right” are merely referring to the directions in the accompanying drawings. Therefore, the used directional terms are intended to illustrate rather than limit the present invention.

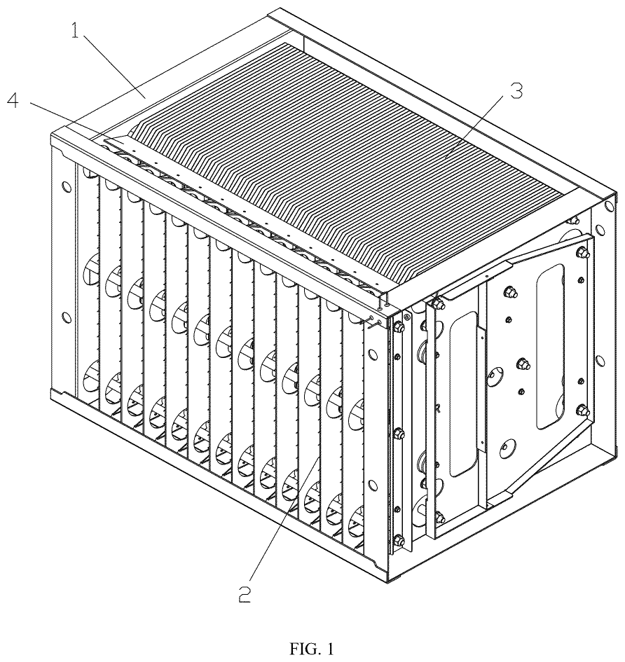

According to an embodiment of the present invention, a vortex electric field purification device is provided. Referring to FIG. 1, the vortex electric field purification device includes a frame 1, where a dust collection area 3 and an ionization area 2 are arranged inside the frame 1 in parallel, both the dust collection area 3 and the ionization area 2 include a plurality of polar plates parallel to each other and arranged at intervals, a minimum distance between high-voltage polar plates of the dust collection area 3 and low-voltage polar plates of the ionization area 2 in a first direction is not less than a distance between low-voltage polar plates and the high-voltage polar plates of the dust collection area 3 in a second direction, the first direction is parallel to a direction from an air inlet side of the purification device to a leeward side of the purification device, the second direction and the first direction are located in a same horizontal plane, and the second direction is perpendicular to the first direction.

In the vortex electric field purification device according to this embodiment, referring to FIG. 1, a minimum distance d₂ between the low-voltage polar plates of the ionization area 2 and the low-voltage polar plates of the dust collection area 3 in the first direction is not less than a distance d₁ between the high-voltage polar plates and the low-voltage polar plates of the dust collection area 3 in the second direction. If a distance between high-voltage polar plates and the low-voltage polar plates of the ionization area 2 is d₄, d₄≥4 d₂. After fully considering the factors of electrical safety and purification efficiency, the inventor found through tests that when d₄≥4 d₂, the vortex electric field purification device can better meet the electrical safety and purification efficiency; and when d₄≤4 d₂, the vortex electric field purification device is prone to arcing ignition or flashover, has low purification efficiency and does not meet the actual operation requirement.

Preferably, the minimum distance between the low-voltage polar plates of the ionization area 2 and the high-voltage polar plates of the dust collection area 3 in the first direction is d₃, 1.5 d₁≤d₃≤2.5 d₁, and similarly, 1.5 d₁≤d₂≤2.5 d₁.

To better ensure the purification efficiency, electrical safety and induced voltage and consider the stability of products in the early and late operation periods, a comparative test was tested, and it was found that the overall performance is the best when the minimum distance between the low-voltage polar plates of the ionization area 2 and the high-voltage polar plates of the dust collection area 3 in the first direction is d₃ and 1.5 d₁≤d₃≤2.5 d₁, and similarly, the overall purification efficiency and the electrical performance are more excellent than this range when 1.5 d₁≤d₂≤2.5 d₁.

In the vortex electric field purification device according to this embodiment, referring to FIG. 1, the high-voltage polar plates and the low-voltage polar plates of the ionization area 2 are respectively connected to a high-voltage power supply, an ionization electric field is formed between the high-voltage polar plates and the low-voltage polar plates of the ionization area 2, the high-voltage polar plates of the dust collection area 3 are activated by the ionization electric field to generate a vortex electric field, and a corresponding relationship between an absolute value of an induced voltage of the vortex electric field and d₁ is:

the absolute value of the induced voltage/d₁=0.7-1.3 kV/mm.

It should be noted that the inventor made a systematic test experiment on a corresponding relationship between the absolute value of the induced voltage and d₁ on the premise of comprehensively considering the primary purification efficiency and electrical safety of the particulate matters and based on the vortex electric field purification device with the same overall size and the same environment operation parameter. The experimental result is shown in Table 1.

TABLE 1
Absolute Value of Induced Voltage/d₁ = 0.7-1.3 kV/mm

| | Distance | Absolute value | | | | | |
|---|---|---|---|---|---|---|---|
| | between high- | of voltages | | | | | |
| | voltage polar | applied to high- | | | | | Primary |
| | plates and low- | voltage polar plates | Absolute | | | Electrical | purification |
| | voltage polar | and low-voltage | value of | | Surface | Safety of | efficiency of |
| | plates of dust | polar plates of dust | induced | | air | Dust | particulate |
| Serial | collection area | collection area | value/d₁ | Temperature | velocity | Collection | matters |
| number | (mm) | (kV) | (kV/mm) | (° C.) | (m/s) | Area | (%) |
| 1 | 6 | 3 | 0.5 | 25 | 4 | No arcing, | 78.3 |
| | | | | | | no | |
| | | | | | | flashover | |
| 2 | 6 | 3.6 | 0.6 | 25 | 4 | No arcing, | 82.6 |
| | | | | | | no | |
| | | | | | | flashover | |
| 3 | 6 | 4.2 | 0.7 | 25 | 4 | No arcing, | 91.5 |
| | | | | | | no | |
| | | | | | | flashover | |
| 4 | 6 | 6 | 1.0 | 25 | 4 | No arcing, | 96.5 |
| | | | | | | no | |
| | | | | | | flashover | |
| 5 | 6 | 7.8 | 1.3 | 25 | 4 | No arcing, | 98.9 |
| | | | | | | no | |
| | | | | | | flashover | |
| 6 | 6 | 8.4 | 1.4 | 25 | 4 | Arcing | <30 |

It can be seen from Table 1 that when the absolute value of the induced voltage/d₁ is less than 0.7, the phenomena of arcing and flashover does not occur in the dust collection area, but the primary purification efficiency of the particulate matters is less than 90%; and when the absolute value of the induced voltage/d₁ is 1.4, the phenomenon of arcing occurs in the dust collection area, and the primary purification efficiency of the particulate matters is less than 30%.

In the vortex electric field purification device according to this embodiment, referring to FIG. 1, the high-voltage polar plates of the ionization area 2 are connected to a high-voltage end of the high-voltage power supply through a conductive rod, an avoiding hole for the conductive rod to penetrate through is formed in each of the low-voltage polar plates of the ionization area 2, the avoiding hole is set as a waist-shaped hole, and if a minimum diameter of the waist-shaped hole is D and an absolute value of a voltage of the ionization electric field is U, D/U≥2 mm/kV.

It should be noted that the inventor made a systematic test experiment on a corresponding relationship of D/U on the premise of comprehensively considering the primary purification efficiency and electrical safety of the particulate matters and based on the vortex electric field purification device with the same overall size and the same environment operation parameter. It is concluded that when D/U≥2 mm/kV, the electrical safety and the purification efficiency of the particulate matters can meet the actual operation requirement; and when D/U<2 mm/kV, the ionization area is also safe and the phenomena of arcing and flashover will not occur, but the primary purification efficiency of the particulate matters is significantly less than 90%, and the actual purification requirement is not met.

In the vortex electric field purification device according to this embodiment, referring to FIG. 1, wind deflectors 4 are arranged at the tops and bottoms of the low-voltage polar plates of the ionization area 2, the wind deflectors 4 are arranged obliquely, and a distance between an end portion of each of the wind deflectors 4 close to the air inlet side of the purification device and the frame 1 is less than a distance between an end portion of each of the wind deflectors close to the leeward side of the purification device and the frame 1.

Specifically, a distance between ionization sawteeth on the high-voltage polar plates of the ionization area 2 and the low-voltage polar plates in the second direction is not greater than a minimum distance of the ionization sawteeth and the wind deflectors 4 in a third direction, the third direction and the first direction are located in a same vertical plane, and the third direction is perpendicular to the first direction.

It should be noted that the structures of the wind deflectors 4 are subjected to optimal design on the basis of verifying an electrical gap, thereby not only ensuring that the ionization voltage will not break down, but also ensuring that the air entering the ionization area will be gathered and converged to flow to the dust collection area.

In the vortex electric field purification device according to this embodiment, referring to FIG. 1, the bottoms of the low-voltage polar plates of the ionization area 2 are connected to the frame 1 through a connecting plate, and a height of the connecting plate is not greater than a height of a lower edge strip of the frame 1.

It should be noted that the connecting plate is conducive to fixing the low-voltage polar plats of the ionization area, and the height of the connecting plate is not greater than the height of the lower edge strip of the frame, so that the effects of no windproofness, low resistance and high space utilization rate are achieved.

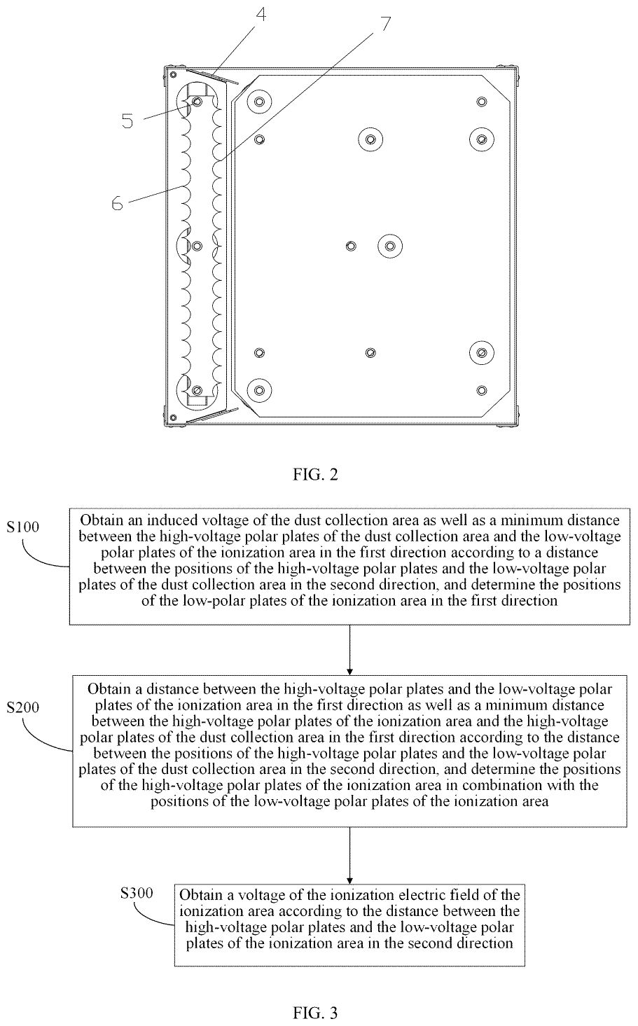

In the vortex electric field purification device according to this embodiment, referring to FIG. 1 and FIG. 2, in the ionization area 2, a mounting hole 5 for the first conductive rod to penetrate through is formed in each of the high-voltage polar plates, a first ionization sawtooth 6 is arranged on a side surface of each of the high-voltage polar plates close to the air inlet side of the purification device, a second ionization sawtooth 7 is arranged on a side surface of each of the high-voltage polar plates close to the leeward side of the purification device, a distance between the first ionization sawtooth 6 and the mounting hole 5 in the first direction serves as a second distance, a distance between the second ionization sawtooth 7 and the mounting hole 5 in the first direction serves as a third distance, and the second distance is less than the third distance.

In the vortex electric field purification device according to this embodiment, referring to FIG. 1, the first ionization sawtooth 6 and the second ionization sawtooth 7 have the same structure, the first ionization sawtooth and the second ionization sawtooth are staggered in a height direction of the purification device, and a difference value between the second distance and the third distance is 3/10 to ½ of a distance between adjacent second ionization sawteeth 7; and the closer the high-voltage polar plates of the ionization area 2 are to the dust collection area 3, the higher the induced voltage is and the higher the primary purification efficiency of the particulate matters is, but when the distance is short to a certain extent, the electrical safety is not easy to control.

Based on the same dust collection area, the inventor designed different ionization areas to perform efficiency test experiments, and found that when the difference value between the second distance and the third distance is 3/10 to ½ of the distance between the adjacent second ionization sawteeth, the primary purification efficiency of the particulate matters can be greater than 90%, the requirement of the actual operation is met, and the experimental results are shown in Table 3.

TABLE 3

| | | | | Primary | |
|---|---|---|---|---|---|
| | | | | Purification | |
| | Ionization Area | | Surface | Efficiency of | |
| | Difference | | Air | Particulate | |
| Serial | ratio | Voltage | Velocity | Matters | Electrical |
| Number | / | KV | m/s | % | Safety |
| 1 | 0.25 | −17 | 4.5 | 98.5 | Easy to cause |
| | | | | | ignition |
| 2 | 0.3 | −17 | 4.5 | 96.6 | Safe |
| 3 | 0.4 | −17 | 4.5 | 94.9 | Safe |
| 4 | 0.5 | −17 | 4.5 | 92.5 | Safe |
| 5 | 0.55 | −17 | 4.5 | 86.7 | Safe |

It can be seen from Table 3 that the high-voltage polar plates of the ionization area are close to the dust collection area, so that the induced voltage can be increased, the purification efficiency can be improved, and the maintenance cycle can be prolonged.

In the vortex electric field purification device according to this embodiment, referring to FIG. 1, the high-voltage polar plates of the ionization area 2 and two low-voltage polar plates adjacent thereto form an ionization interval C₁, the high-voltage polar plates of the dust collection area 3 and two low-voltage polar plates adjacent thereto form a dust collection interval C₂, and in the second direction, C₁≥3 C₂. The ionization area requires a higher voltage to ionize the air to charge the passing particulate matters, and the dust collection area requires a reasonably designed voltage to capture the charged particulate matters. It is found through the test that better purification effect and electrical safety can be achieved when C₁≥3 C₂, and poor purification efficiency and electrical safety can be achieved when C₁≤3 C₂, which is not conducive to stabilizing the performance of long-time operation and maintaining the electrical safety.

According to an embodiment of the present invention, a method for designing a vortex electric field purification device is provided. Referring to FIG. 3, the method includes the following steps:
an induced voltage of the dust collection area as well as a minimum distance between the high-voltage polar plates of the dust collection area and the low-voltage polar plates of the ionization area in the first direction are obtained according to a distance between the positions of the high-voltage polar plates and the low-voltage polar plates of the dust collection area in the second direction, and the positions of the low-polar plates of the ionization area in the first direction is determined;
a distance between the high-voltage polar plates and the low-voltage polar plates of the ionization area in the first direction as well as a minimum distance between the high-voltage polar plates of the ionization area and the high-voltage polar plates of the dust collection area in the first direction are obtained according to the distance between the positions of the high-voltage polar plates and the low-voltage polar plates of the dust collection area in the second direction, and the positions of the high-voltage polar plates of the ionization area is determined in combination with the positions of the low-voltage polar plates of the ionization area; and
a voltage of the ionization electric field of the ionization area is obtained according to the distance between the high-voltage polar plates and the low-voltage polar plates of the ionization area in the second direction.

Preferably, the distance between the high-voltage polar plates and the low-voltage polar plates of the ionization area is 24 mm, the distance between the high-voltage polar plates and the low-voltage polar plates of the dust collection area is 6 mm, the absolute value of the voltage of the ionization electric field is 12 kV, the absolute value of the induced voltage is 6 kV, and the primary purification efficiency of the particulate matters is the best.

In the method for designing the vortex electric field purification device according to the embodiment, if the distance between the high-voltage polar plates and the low-voltage polar plates of the ionization area in the second direction is d₄, 0.5 kV/mm≤the absolute value of the voltage of the ionization electric field of the ionization area/d₄≤1 kV/mm.

It should be noted that based on the same dust collection area, the inventor designed different ionization areas to perform a test experiment on the primary purification efficiency of the particulate matters, and found that when 0.5 kV/mm≤the absolute value of the voltage of the ionization electric field of the ionization area/d₄≤1 kV/mm, the primary purification efficiency of the particulate matters can be greater than 90%, and the actual operation requirement is met. The experimental result is shown in Table 4.

TABLE 4
0.5 kV/mm ≤ Voltage of Ionization Electric Field of Ionization Area/d₄ ≤ 1 kV/mm

| | Distance | Absolute value of | Absolute value | | | | |
|---|---|---|---|---|---|---|---|
| | between | voltages applied | of voltage | | | | |
| | high-voltage | to high-voltage | of ionization | | | | Primary |
| | polar plates | polar plates | electric | | | Electrical | purification |
| | and low-voltage | and low-voltage | field of | | Surface | safety | efficiency of |
| | polar plates of | polar plates of | ionization | | air | condition of | particulate |
| Serial | ionization area | ionization area | area/d₄ | Temperature | velocity | ionization | matters |
| number | (mm) | (kV) | (kV/mm) | (° C.) | (m/s) | area | (%) |
| 1 | 24 | 9.6 | 0.40 | 25 | 4 | No | 83.1 |
| | | | | | | arcing, no | |
| | | | | | | flashover | |
| 2 | 24 | 12 | 0.50 | 25 | 4 | No | 91.6 |
| | | | | | | arcing, no | |
| | | | | | | flashover | |
| 3 | 24 | 14.4 | 0.60 | 25 | 4 | No | 92.4 |
| | | | | | | arcing, no | |
| | | | | | | flashover | |
| 4 | 24 | 16.8 | 0.70 | 25 | 4 | No | 93.3 |
| | | | | | | arcing, no | |
| | | | | | | flashover | |
| 5 | 24 | 19.1 | 0.80 | 25 | 4 | No | 95.7 |
| | | | | | | arcing, no | |
| | | | | | | flashover | |
| 6 | 24 | 21.6 | 0.90 | 25 | 4 | No | 96.5 |
| | | | | | | arcing, no | |
| | | | | | | flashover | |
| 7 | 24 | 24 | 1.00 | 25 | 4 | No | 97.8 |
| | | | | | | arcing, no | |
| | | | | | | flashover | |
| 8 | 24 | 26.4 | 1.10 | 25 | 4 | Arcing | <30 |

The present invention has been described in detail above, and the above are only preferred embodiments of the present invention and are not intended to limit the implementation scope of the present invention, that is, all equivalent variations and modifications made within the claims of the present invention shall be included within the scope of the present invention.

What is claimed is:

1. A vortex electric field purification device, characterized in that, comprising a frame, wherein a dust collection area and an ionization area are arranged inside the frame in parallel, the dust collection area and the ionization area each comprise a plurality of polar plates parallel to each other and arranged at intervals, a minimum distance between high-voltage polar plates of the dust collection area and low-voltage polar plates of the ionization area in a first direction is not less than a distance between low-voltage polar plates and the high-voltage polar plates of the dust collection area in a second direction, the first direction is parallel to a direction from an air inlet side of the purification device to a leeward side of the purification device, the second direction and the first direction are located in a same horizontal plane, and the second direction is perpendicular to the first direction.

2. The vortex electric field purification device according to claim 1, characterized in that, a minimum distance d₂ between the low-voltage polar plates of the ionization area and the low-voltage polar plates of the dust collection area in the first direction is not less than a distance d₁ between the high-voltage polar plates and the low-voltage polar plates of the dust collection area in the second direction.

3. The vortex electric field purification device according to claim 2, characterized in that, if a distance between high-voltage polar plates and the low-voltage polar plates of the ionization area is d₄, d₄≥4 d₂.

4. The vortex electric field purification device according to claim 3, characterized in that, the high-voltage polar plates and the low-voltage polar plates of the ionization area are respectively connected to a high-voltage power supply, an ionization electric field is formed between the high-voltage polar plates and the low-voltage polar plates of the ionization area, the high-voltage polar plates of the dust collection area are activated by the ionization electric field to generate a vortex electric field, and a corresponding relationship between an absolute value of an induced voltage of the vortex electric field and d₁ is:
the absolute value of the induced voltage/d₁=0.7-1.3 kV/mm.

5. The vortex electric field purification device according to claim 1, characterized in that, the high-voltage polar plates of the ionization area are connected to a high-voltage end of the high-voltage power supply through a conductive rod, an avoiding hole for the conductive rod to penetrate through is formed in each of the low-voltage polar plates of the ionization area, the avoiding hole is set as a waist-shaped hole, and if a minimum diameter of the waist-shaped hole is D and an absolute value of a voltage of the ionization electric field is U, D/U≥2 mm/kV.

6. The vortex electric field purification device according to claim 1, characterized in that, wind deflectors are arranged at the tops and bottoms of the low-voltage polar plates of the ionization area, the wind deflectors are arranged obliquely, and a distance between an end portion of each of the wind deflectors close to the air inlet side of the purification device and the frame is less than a distance between an end portion of each of the wind deflectors close to the leeward side of the purification device and the frame.

7. The vortex electric field purification device according to claim 6, characterized in that, a distance between ionization sawteeth on the high-voltage polar plates of the ionization area and the low-voltage polar plates in the second direction is not greater than a minimum distance of the ionization sawteeth and the wind deflectors in a third direction, the third direction and the first direction are located in a same vertical plane, and the third direction is perpendicular to the first direction.

8. The vortex electric field purification device according to claim 1, characterized in that, the bottoms of the low-voltage polar plates of the ionization area are connected to the frame through a connecting plate, and a height of the connecting plate is not greater than a height of a lower edge strip of the frame.

9. The vortex electric field purification device according to claim 1, characterized in that, in the ionization area, a mounting hole for the first conductive rod to penetrate through is formed in each of the high-voltage polar plates, a first ionization sawtooth is arranged on a side surface of each of the high-voltage polar plates close to the air inlet side of the purification device, a second ionization sawtooth is arranged on a side surface of each of the high-voltage polar plates close to the leeward side of the purification device, a distance between the first ionization sawtooth and the mounting hole in the first direction serves as a second distance, a distance between the second ionization sawtooth and the mounting hole in the first direction serves as a third distance, and the second distance is less than the third distance.

10. The vortex electric field purification device according to claim 9, characterized in that, the first ionization sawtooth and the second ionization sawtooth have the same structure, the first ionization sawtooth and the second ionization sawtooth are staggered in a height direction of the purification device, and a difference value between the second distance and the third distance is 3/10 to ½ of a distance between adjacent second ionization sawtecth.

11. The vortex electric field purification device according to claim 1, characterized in that, the high-voltage polar plates of the ionization area and two low-voltage polar plates adjacent thereto form an ionization interval C₁, the high-voltage polar plates of the dust collection area and two low-voltage polar plates adjacent thereto form a dust collection interval C₂, and in the second direction, C₁≥3 C₂.

12. The vortex electric field purification device according to claim 3, characterized in that, in the second direction, a distance between a sawtooth tip of the high-voltage polar plates of the ionization area close to the air inlet side and the low-voltage polar plates adjacent thereto is d₅, and in the first direction, a width of each of the high-voltage polar plates and the low-voltage polar plates of the ionization area is three times d₅.

13. A method for designing the vortex electric field purification device according to claim 1, comprising the following steps:
obtaining an induced voltage of the dust collection area as well as a minimum distance between the high-voltage polar plates of the dust collection area and the low-voltage polar plates of the ionization area in the first direction according to a distance between the positions of the high-voltage polar plates and the low-voltage polar plates of the dust collection area in the second direction, and determining the positions of the low-polar plates of the ionization area in the first direction;
obtaining a distance between the high-voltage polar plates and the low-voltage polar plates of the ionization area in the first direction as well as a minimum distance between the high-voltage polar plates of the ionization area and the high-voltage polar plates of the dust collection area in the first direction according to the distance between the positions of the high-voltage polar plates and the low-voltage polar plates of the dust collection area in the second direction, and determining the positions of the high-voltage polar plates of the ionization area in combination with the positions of the low-voltage polar plates of the ionization area; and
obtaining a voltage of the ionization electric field of the ionization area according to the distance between the high-voltage polar plates and the low-voltage polar plates of the ionization area in the second direction.

14. The method for designing the vortex electric field purification device according to claim 13, characterized in that, if the distance between the high-voltage polar plates and the low-voltage polar plates of the ionization area in the second direction is d₄, 0.5 kV/mm≤the absolute value of the voltage of the ionization electric field of the ionization area/d₄≤1 kV/mm.
